(19) United States
(12) Patent Application Publication
(10) Pub. No.: US 2014/0109882 A1
(43) Pub. Date: Apr. 24, 2014

(54) METHOD FOR MONITORING THE LEAK TIGHTNESS OF A FUEL TANK SYSTEM

(71) Applicants: Johannes Hoegl, Stuttgart (DE); Silke Haag, IIsfeld-Ausenstein (DE); Guenther Koessler, Schwieberdingen (DE); Andreas Pape, Oberriexingen (DE); Thomas Herges, Eberdingen (DE); Cam Lai Ngo, Ditzingen (DE); Guido Schock, Loewenstein (DE)

(72) Inventors: Johannes Hoegl, Stuttgart (DE); Silke Haag, IIsfeld-Ausenstein (DE); Guenther Koessler, Schwieberdingen (DE); Andreas Pape, Oberriexingen (DE); Thomas Herges, Eberdingen (DE); Cam Lai Ngo, Ditzingen (DE); Guido Schock, Loewenstein (DE)

(73) Assignee: ROBERT BOSCH GMBH, Stuttgart (DE)

(21) Appl. No.: 14/057,228

(22) Filed: Oct. 18, 2013

(30) Foreign Application Priority Data
Oct. 18, 2012 (DE) 10 2012 219 048.1

(51) Int. Cl. F02B 37/12

(52) U.S. Cl. CPC F02B 37/12
USPC 123/559.1

(57) ABSTRACT

A method for monitoring the leak tightness of a fuel tank system is provided, the fuel tank system being provided for supplying fuel to a supercharged internal combustion engine. A pressure accumulator is filled from the supercharged intake manifold area of the internal combustion engine. The pressure from the pressure accumulator is transferred to the fuel tank system, which includes in particular the fuel tank and, if necessary, an activated carbon filter. The pressure curve in the closed fuel tank system is observed. A leak in the fuel tank system may be inferred on the basis of the pressure curve, if necessary.

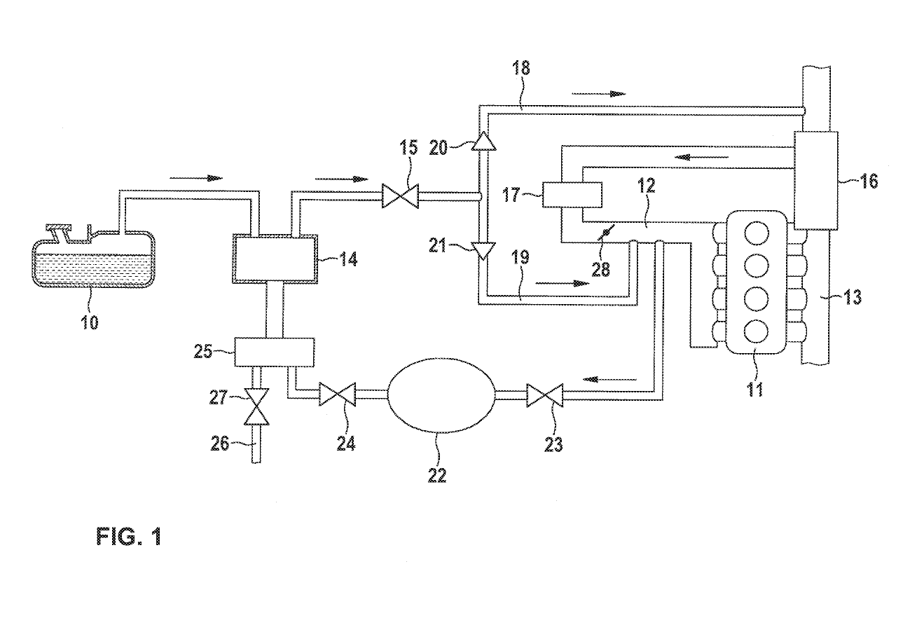

### CROSS REFERENCE TO RELATED APPLICATION

The present application claims priority to Application No. DE 10 2012 219 048.1, filed in the Federal Republic of Germany on Oct. 18, 2012, which is expressly incorporated herein in its entirety by reference thereto.

### FIELD OF INVENTION

The present invention relates to a method for monitoring the leak tightness of a fuel tank system, a fuel tank system which is suitable for carrying out this method, a method for regenerating an adsorption filter for fuel vapors in a corresponding fuel tank system as well as a computer program and a computer program product having program code which are suitable for carrying out this method.

### BACKGROUND INFORMATION

With the fuel tank of a motor vehicle, it is important to ensure that there is no leakage of liquid or gaseous fuel. It is therefore necessary to monitor the leak tightness of the fuel tank system to detect a leak in the system, if necessary. In some countries, leakage detection in the fuel system is required by law to detect environmental emissions and eliminate the leakages.

Various methods are already known for leak testing of the fuel tank system. For example, a passive leak test may be carried out based on the natural ambient temperature fluctuations. This method is based on the fact that various underpressures and overpressures occur in the tank system due to the natural temperature fluctuations during the shut-down phase of the motor vehicle. The pressure would be equalized if a leak is present. A leak may be assumed if the underpressures or overpressures occurring in the tank system due to the natural temperature fluctuations are not maintained or dissipate too rapidly. However, this method has the disadvantage that it is impossible to diagnose other components. In addition, the diagnosis is very vague when there are minor temperature changes in the environment, yielding unsatisfactory results.

In another approach, an active leak test is carried out with the aid of a pressure pump. A pressure is applied to the tank system with the aid of a pressure source, for example, an electric pump. The curve of the built-up pressure is observed, for example, by a direct pressure measurement or an equivalent measured variable, and compared with a reference curve. If there is any leakage, the actual pressure curve will deviate from the reference curve. This method permits relatively reliable detection of a leak. However, one disadvantage here is that an additional pressure pump, i.e., in particular an electric pump, must generally be used as an active component, which is associated with corresponding additional costs.

Unexamined German Patent Application NO. DE 41 24 465 describes a similar method for testing the leak tightness of a tank venting system. Pressure is applied to the tank venting system via a secondary air source in this test method. This secondary compressed air source may be the turbocharger of a supercharged internal combustion engine, for example. The leak tightness of the tank venting system is evaluated by comparing the measurable pressure with a predefined pressure condition. However, this method is subject to relatively great inaccuracies in the buildup of pressure and thus yields relatively inaccurate results.

In comparison with the related art, the present invention is based on an object of providing an improved method of monitoring the leak tightness of a fuel tank system, which allows reliable and precise monitoring of leakages in the fuel tank, in the tank vent area and/or in the various lines of the system with little extra effort. This object is achieved by a method for monitoring the leak tightness of a fuel tank system according to the present invention. Preferred exemplary embodiments of this method and a fuel tank system suitable for carrying out this method, as well as a computer program and a computer program product for carrying out the method are described herein.

### SUMMARY

The method according to the present invention for monitoring the leak tightness of a fuel tank system is directed to a fuel tank system which is provided for supplying fuel to a supercharged internal combustion engine. With such a supercharged internal combustion engine, a compressor which is generally driven by an exhaust gas turbine is situated in the intake system of the internal combustion engine. A greater efficiency of the internal combustion engine is achievable by compression of the supplied fresh air. The compression in the intake area of the internal combustion engine is utilized according to the present invention to fill a pressure accumulator. The pressure accumulator is connected to the supercharged intake manifold area of the internal combustion engine via a line and may be supercharged and filled by opening an appropriate valve. The temporarily stored pressure from the pressure accumulator is transferred to the fuel tank system. The pressure curve in the closed fuel tank system is then observable and, based on this pressure curve, a leak in the fuel tank system may be inferred, as the case may be.

The pressure accumulator is preferably filled up to a certain pressure level. The pressure accumulator is filled up to a maximum pressure pₘₐₓ in particular.

The pressure is transferred from the pressure accumulator and/or the pressure curve in the closed fuel tank system is preferably observed during overrun operation of the internal combustion engine. This is advantageous in particular since a vehicle movement due to the occurring fuel fumigation would generally have a negative influence on the selectivity of the method according to the present invention. A certain period of time is also required for carrying out the method, this period of time being available in particular during overrun operation of the internal combustion engine.

The pressure in the fuel tank system and/or the pressure in the pressure accumulator is/are preferably monitored, for example, by corresponding pressure sensors and/or by indirect methods, for example, by modeling of the pressure on the basis of other variables.

By opening a valve between the pressure accumulator and the fuel tank system, the temporarily stored pressure enters the fuel tank system. The pressure is preferably transferred until a predefinable pressure level in the tank system is reached, in particular the diagnostic starting point p_{diag}, to achieve defined starting conditions for the diagnosis.

After transferring the pressure from the pressure accumulator to the fuel tank system, the valve between the pressure accumulator and the fuel tank system is closed, thereby isolating the fuel tank system. The pressure curve in the fuel tank system may thus be observed and, based on this curve, a possible leak may be inferred. The pressure curve is monitorable with the aid of a pressure sensor, which is present if necessary. In addition, it is possible in principle to observe the pressure on the basis of another characterizing variable, for example, on the basis of the temperature curve in the fuel tank, since the temperature is a measure for the fumigation of the fuel, which in turn depends on the pressure in the system.

In one preferred exemplary embodiment of the method according to the present invention, the pressure curve is tracked over a predefinable period of time after transferring the pressure from the pressure accumulator into the fuel tank system. It is advantageously possible here to check on whether, within the predefinable period of time, a predefinable threshold value for a variable characterizing the pressure is reached or falls short. If the pressure drops below the predefinable threshold value in the predefinable period of time, it may be inferred that the pressure in the fuel tank system could be maintained only inadequately and consequently a leak is present. Another possibility is to predefine the threshold value as a value for a pressure range, which represents a tolerable pressure drop. If this range is exceeded, a leak must be inferred.

The threshold value for the pressure drop in the fuel tank system may be calculated from various variables, in particular as a function of the ambient temperature and/or the temperature in the fuel tank and/or the ambient air pressure and/or the fuel tank filling level. The corresponding variables may be stored in the control unit of the motor vehicle, for example, and used for calculating the threshold value adapted to the prevailing conditions.

Depending on the characteristic of the pressure curve in the fuel tank system in the course of the method according to the present invention, it may be inferred whether or not a leak is present. In addition, the extent of the leakage may be inferred from the corresponding shape of the curve, so that it is possible to differentiate a major leak from a minor leak, for example.

The present invention also includes a fuel tank system which is provided for supplying fuel to a supercharged internal combustion engine. According to the present invention, at least one pressure accumulator which is chargeable via the supercharged intake area of the internal combustion engine is assigned to the fuel tank system. At least one valve whose opening and closing regulate and/or control the filling of the pressure accumulator is provided between the pressure accumulator and the intake area of the internal combustion engine. In addition, at least one additional valve is situated between the pressure accumulator and the remaining fuel tank system to be able to transfer pressure from the pressure accumulator into the fuel tank system in a controlled manner. The fuel tank system may thus be acted upon with a defined pressure. The leak tightness of the fuel tank system may be monitored in the manner described above on the basis of the pressure curve in the closed and isolated fuel tank system.

The fuel tank system according to the present invention preferably also includes at least one adsorption filter, in particular an activated carbon filter, which is provided for adsorbing fuel vapors from the fuel tank. Fuel vapors regularly occur in the fuel tank as a result of fluctuations in temperature and pressure. Tank venting is a functionality required by law. To prevent emission of volatile hydrocarbons from the tank, today's motor vehicles are generally provided with equipment for capturing fuel vapors, in particular an activated carbon filter which adsorbs the volatile hydrocarbons. The vent line of the fuel tank opens into this activated carbon filter. Another line runs from the activated carbon filter to the intake manifold of the internal combustion engine, so that fuel vapors from the activated carbon filter may be sent for combustion by this route. A tank vent valve is usually provided in the line between the activated carbon filter and the intake manifold of the internal combustion engine. This valve is opened to vent the tank. Ambient air is drawn in through the activated carbon filter during engine operation via a vent opening or vent line of the activated carbon filter, so that regeneration or flushing of the activated carbon may take place with the tank vent valve open during engine operation. The fuel entrained by the flushing stream is sent for combustion in a targeted manner. With the fuel tank system according to the present invention, the pressure accumulator is preferably situated between the area of the activated carbon filter or the adsorption filter provided for the ambient air supply and the supercharged intake area of the internal combustion engine. The temporarily stored pressure in the pressure accumulator is thus introduced into the fuel tank system through the adsorption filter. The corresponding inlet line to the activated carbon filter is preferably equipped with a switching valve here, so that it is possible to switch between an ambient air feed and a feed from the pressure accumulator if necessary.

Due to this design of the fuel tank system according to the present invention, the flushing and regeneration of the activated carbon filter may still be carried out in a particularly advantageous manner. The present invention therefore also includes a method for regenerating an adsorption filter for fuel vapors, in particular an activated carbon filter, in a fuel tank system of a supercharged internal combustion engine, in which the adsorption filter is regenerated by flushing of the adsorption filter with ambient air and discharge of the flushing stream in the direction of the intake manifold of the internal combustion engine. The pressure accumulator provided in the fuel tank system according to the present invention allows the filter to be acted upon by a pressure from the pressure accumulator during flushing of the activated carbon filter, so that the pressure accumulator is supercharged via the supercharged intake area of the internal combustion engine. A more uniform triggering of the tank vent valve is achievable in a particularly advantageous manner in this way, so that the influences from the loaded state of the activated carbon filter during tank venting may be minimized and thereby improving the drivability. This may be achieved in particular by a calculation of the mass flow via the tank vent valve, the known pressure from the pressure accumulator and the known pressure in the intake manifold between the throttle device and the intake valves of the internal combustion engine entering into the calculation of the mass flow via the tank vent valve. Depending on the change in the intake manifold pressure, the valve between the intake manifold and the activated carbon filter may be opened to varying amounts, so that the proportional amount of the internal combustion engine filling from the regeneration gas or from the flushing stream of the activated carbon filter and the fresh air remains constant.

Finally, the present invention includes a computer program, which carries out all steps of the methods described above when executed on a computer or a control unit, as well as a computer program product having program code stored on a machine-readable carrier, for carrying out the methods according to the present invention when the program is executed on a computer or a control unit. Implementation of the methods according to the present invention as a computer program or as a computer program product has an advantage that this program is readily usable in existing motor vehicles by running the computer program in the control unit of the motor vehicle, for example. Thus, if a corresponding pressure accumulator is present in the system, the advantages of the methods according to the present invention may be utilized with the aid of the computer program or the computer program product according to the present invention, to thereby be able to carry out a very reliable monitoring of the leak tightness of the fuel tank system according to the monitoring method according to the present invention in particular. In addition, the flushing and regeneration of an adsorption filter in a fuel tank system may be improved in the manner described above using a computer program or computer program product according to the present invention to minimize the influences of the loaded state of the adsorption filter during tank venting through appropriate switching of the valves and thus to optimize the drivability during tank venting.

Additional features and advantages of the present invention are described in the following description of exemplary embodiments with reference to the accompanying drawing. Individual features may be implemented here individually or in any combination with one another.

### BRIEF DESCRIPTION OF THE DRAWING

The FIGURE shows a schematic diagram of the components of a fuel tank system including a supercharged internal combustion engine thereby supplied with fuel.

### DETAILED DESCRIPTION

The fuel tank system shown in the FIGURE includes initially a fuel tank 10 for supplying fuel to internal combustion engine 11. The fuel is sent to internal combustion engine 11 via an intake manifold 12. This does not show the direct feed line for fuel from fuel tank 10 to the intake area. The exhaust gases leave internal combustion engine 11 through exhaust tract 13. Evaporating fuel from tank 10 is captured and stored in an activated carbon filter 14. The stored fuel vapors from the activated carbon filter may be supplied to internal combustion engine 11 by opening a tank vent valve 15. A turbocharger 16 is situated in intake area 12 of internal combustion engine 11 for compression of the supplied fresh air to thereby increase the efficiency of the internal combustion engine. Since compression raises the temperature of the mixture, a charge air cooler 17 is provided to cool down the temperature of the charge air before the fuel mixture is supplied to internal combustion engine 11 via a throttle device 28. Turbocharger 16 is driven via the exhaust stream in exhaust tract 13. The tank may be vented through tank vent valve 15 via lines 18 and 19, which open downstream from turbocharger 16 and upstream from charge air cooler 17. Lines 18 and 19 are each equipped with a check valve 20, 21.

According to the present invention, a pressure accumulator 22 is provided in the system and is connected via a line to supercharged intake area 12 of internal combustion engine 11. Pressure accumulator 22 is superchargeable by opening a valve 23 between intake area 12 and pressure accumulator 22. Another valve 24 is provided between pressure accumulator 22 and the remaining fuel tank system. By opening this valve 24, the pressure from pressure accumulator 22 may be transferred into the fuel tank system. In this exemplary embodiment of the fuel tank system, the pressure is introduced into the fuel tank system from pressure accumulator 22 via activated carbon filter 14. For this purpose, a line is provided which opens in the area of the inlet line of activated carbon filter 14 provided for ambient air intake. A switching valve 25 allows switching between an ambient air intake via line 26 or a transfer of pressure from pressure accumulator 22. An activated carbon filter cutoff valve 27 is also provided.

The core of the present invention is that pressure accumulator 22 is provided in the system, this pressure accumulator being supercharged via supercharged intake area 12 of internal combustion engine 11. The pressure from pressure accumulator 22 is transferred to the fuel tank system, which is made up of fuel tank 10, activated carbon filter 14 and the corresponding lines. The fuel tank system is pressure-isolated from the remaining system by closing the appropriate valves. The subsequent pressure curve in the closed fuel tank system is observed. It is possible to determine on the basis of this curve whether a leak is present in the fuel tank system. If this is the case, then a corresponding defect may be assumed. An advantage here is that no additional active pressure source in the fuel tank system is required to build up the pressure in the fuel tank system. Instead, the compression occurring in the intake area of internal combustion engine 11 may be utilized by turbocharger 16 to apply a pressure to the fuel tank system. According to the present invention, a pressure accumulator 22 is used for this purpose to allow temporary storage of the pressure in a defined manner during operation of internal combustion engine 11 and to be able to send the pressure to the fuel tank system in a controlled manner during overrun operation of the internal combustion engine in particular.

The method according to the present invention may be carried out such that, for example, pressure accumulator 22 is supercharged up to a maximum pressure pₘₐₓ by opening valve 23 during engine operation starting from an area 12 supercharged by turbocharger 16 in the intake manifold of internal combustion engine 11. By opening valve 24 and with appropriate switching of switching valve 25 during overrun operation of the internal combustion engine, the tank system is acted upon with a pressure from pressure accumulator 22. This is preferably carried out until a defined starting point for the diagnosis in the tank system, in particular diagnostic starting point pressure p_{diag}, is reached. This procedure is monitorable using a pressure sensor, which may be situated at various locations in the tank system, or by indirect measurement methods, for example. Valve 24 is subsequently closed. Since tank vent valve 15 is also closed, the pressure in the closed fuel tank system is more or less maintained. Depending on how rapidly the pressure in the system drops, it may be inferred whether or not a leak is present in the system. The pressure is therefore preferably observed over a predefinable period of time (Δt). A leak may be detected if the pressure drops to a predefinable threshold value in this period of time or if a pressure drop greater than a predefinable threshold value is observed. The threshold value may be calculated in particular as a function of various environmental factors which influence the pressure conditions in the tank system. The ambient temperature and/or the temperature in the fuel tank and/or the ambient air pressure and/or the tank filling level may be taken into account in particular.

The pressure in the fuel tank system may be detected on the basis of corresponding pressure sensor values. In addition, it is possible to observe the pressure via other variables which are dependent on the pressure. For example, the observation of the temperature curve in the tank system is suitable in principle for this purpose since the temperature is a measure for the fumigation of the fuel, which in turn depends on the pressure in the fuel tank in particular.

In addition, particularly advantageous flushing and regeneration of activated carbon filter 14 may be carried out with the fuel tank system described above, which contains the additional pressure accumulator 22. By using the temporarily stored pressure in pressure accumulator 22 during the flushing of activated carbon filter 14, a particularly uniform triggering of tank vent valve 15 is made possible due to the excess overpressure, generated by turbocharger 16, in intake area 12 of internal combustion engine 11. Activated carbon filter 14 is acted upon with a pressure from pressure accumulator 22 during the regeneration process. The mass flow through tank vent valve 15 is calculable by knowing the pressure in pressure accumulator 22 and by knowing the pressure in intake manifold 12 between throttle device 28 and the intake valves of internal combustion engine 11. Depending on the change in the intake manifold pressure, valve 15 between intake manifold 12 and activated carbon filter 14 is opened to varying degrees, so that the proportional amount of engine filling from the flushing gas and the regeneration gas from activated carbon filter 14 and from the fresh air may be kept constant. The influences on engine operation during tank venting may be minimized in this way by the different degrees of filling of activated carbon filter 14, so that the drivability of the motor vehicle is definitely improvable during the tank venting operation in particular.

What is claimed is:

1. A method for monitoring leak tightness of a fuel tank system, the fuel tank system being adapted for supplying fuel to a supercharged internal combustion engine, the method comprising:
filling a pressure accumulator from a supercharged intake manifold area of the internal combustion engine,
transferring a pressure from the pressure accumulator into the fuel tank system,
observing a pressure curve in the fuel tank system, the fuel tank system being closed, and
determining a presence of a leak in the fuel tank system based on the pressure curve.

2. The method according to claim 1, wherein the pressure accumulator is filled up to a maximum pressure.

3. The method according to claim 1, wherein the pressure is transferred from the pressure accumulator into the fuel tank system during overrun operation of the internal combustion engine.

4. The method according to claim 1, further comprising:
monitoring the pressure during the transfer of the pressure from the pressure accumulator into the fuel tank system, the transfer of the pressure into the fuel tank system taking place until a diagnostic starting point pressure is reached.

5. The method according to claim 1, wherein the pressure curve in the fuel tank system is observed based on a variable characterizing the pressure, or based on a temperature curve in the fuel tank system.

6. The method according to claim 1, wherein the pressure curve in the fuel tank system is observed within a predefinable period of time, the pressure curve being checked as to whether a measured value falls below a predefinable threshold value of a variable characterizing the pressure within the predefinable period of time and/or whether a drop in a variable characterizing the pressure by more than a predefinable threshold value is discernible.

7. The method according to claim 6, wherein the threshold value is ascertained as a function of at least one of ambient temperature, a temperature in the fuel tank, ambient air pressure, or a fuel tank filling level.

8. A fuel tank system for supplying fuel to a supercharged internal combustion engine, comprising:
at least one pressure accumulator adapted to be chargeable via a supercharged intake area of the internal combustion engine, and assigned to the fuel tank system,
at least one valve situated between the pressure accumulator and the supercharged intake area of the internal combustion engine, and
at least one additional valve situated between the pressure accumulator and a remaining fuel tank system.

9. The fuel tank system according to claim 8, further comprising:
at least one adsorption filter or an activated carbon filter, adapted for adsorbing fuel vapors from the fuel tank system, the pressure accumulator preferably being situated between the supercharged intake area of the internal combustion engine and an area of the adsorption filter provided for intake of ambient air.

10. A method for regeneration of an adsorption filter or an activated carbon filter for fuel vapors in a fuel tank system of a supercharged internal combustion engine, comprising:
regenerating the adsorption filter by flushing the adsorption filter with ambient air, and
discharging a flushing stream in a direction of an intake manifold of the internal combustion engine,
wherein the filter is acted upon by a pressure from a pressure accumulator during flushing of the adsorption filter, the pressure accumulator being supercharged via a supercharged intake area of the internal combustion engine.

11. A computer program product including a non-transitory, machine-readable medium having program code stored thereon, which, when executed by a computer or a control unit, performs:
a method for monitoring leak tightness of a fuel tank system, the fuel tank system being adapted for supplying fuel to a supercharged internal combustion engine, the method comprising:
filling a pressure accumulator from a supercharged intake manifold area of the internal combustion engine,
transferring a pressure from the pressure accumulator into the fuel tank system,
observing a pressure curve in the fuel tank system, the fuel tank system being closed, and
determining a presence of a leak in the fuel tank system based on the pressure curve; or
a method for regeneration of an adsorption filter or an activated carbon filter for fuel vapors in a fuel tank system of a supercharged internal combustion engine, comprising:
regenerating the adsorption filter by flushing the adsorption filter with ambient air, and
discharging a flushing stream in a direction of an intake manifold of the internal combustion engine,
wherein the filter is acted upon by a pressure from a pressure accumulator during flushing of the adsorption filter, the pressure accumulator being supercharged via a supercharged intake area of the internal combustion engine.
